(19) United States
(12) Patent Application Publication
(10) Pub. No.: US 2004/0079247 A1
(43) Pub. Date: Apr. 29, 2004

(54) Printing unit of a web-fed rotary press for newspaper printing

(75) Inventor: Norbert Dylla, Stadtbergen (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 10/684,084

(22) Filed: Oct. 10, 2003

(30) Foreign Application Priority Data
Oct. 26, 2002 (DE) 102 49 947.0

(51) Int. Cl. B41F 7/04

(52) U.S. Cl. 101/217

(57) ABSTRACT

A printing unit of a web-fed rotary printing press for newspaper printing includes forme cylinder which is six upright broadsheet pages in width and a transfer cylinder which is six upright broadsheet pages in width and has three clamping channels for clamping three rubber blankets, wherein each blanket is two pages in width, wherein the clamping channels are offset from each other by approximately 120°.

### BACKGROUND OF THE INVENTION

1. Field of the Invention

The invention relates to a printing unit of a web-fed rotary press for newspaper printing having a forme cylinder, a transfer cylinder, and an impression cylinder, each of which is six broadsheet pages in width, wherein the transfer cylinder has three clamping channels for clamping three rubber blankets, wherein each blanket is two pages in width.

2. Description of the Related Art

In large newspaper presses, generally four upright broadsheet pages are arranged on a forme cylinder in the axial direction and two broadsheet pages in the circumferential direction. In the case of offset printing, two rubber blankets are usually provided in the axial direction on the associated transfer cylinder. The two rubber blankets are clamped in a respective clamping channel running in the axial direction. The forme cylinder is filled with pages by means of printing plates, one broadsheet page usually being located on one printing plate. As the web, four pages in width, is always cut longitudinally in the middle after printing, the circumferential position of the printing plates on one longitudinal half of the forme cylinder does not have to coincide with that of the printing plates on the other longitudinal half, i.e. the printing plates can be arranged offset on the cylinder circumference.

This possibility is used to reduce the excitation of oscillation of the cylinders by the clamping channels for printing plates and rubber blankets. If the clamping channels on the first longitudinal half of a cylinder are at a different location to those on the second longitudinal half, then the contact force between the printing-unit cylinders is not interrupted in the region of the clamping channels over the entire cylinder width, which reduces the excitation of oscillation.

An offset angle of 90° between the clamping channels of the two cylinder halves is customary in newspaper presses having four printing plates across their width and two plates along their circumference. The clamping channels of the transfer cylinder are likewise offset in the circumferential direction by 90° in relation to one another.

The abovementioned offset of the clamping channels cannot be used in the case of printing-unit cylinders which are six broadsheet pages in width.

### SUMMARY OF THE INVENTION

It is an object of the invention to arrange the clamping channels in a printing unit having a transfer cylinder which is six upright broadsheet pages in width, such that the excitation of oscillation is kept low.

This object is achieved by clamping channels which are offset from each other by approximately 120°. As a result of this arrangement, only one clamping channel, two pages in length, comes into contact at any one time with an adjacent cylinder when the transfer cylinder is in rolling contact, so that the contact force is never interrupted on more than a third of the cylinder. Moreover, the proposed arrangement of the clamping channels achieves a balanced distribution of mass both in the transfer cylinder and in the forme cylinder, producing only slight unbalances.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a schematic plan view of a printing unit of a web-fed rotary press having a forme, transfer and impression cylinder;

FIG. 2 shows the section II-II according to FIG. 1;

FIG. 3 shows the section III-III according to FIG. 1;

FIG. 4 shows the section IV-IV according to FIG. 1;

FIG. 5 shows a double printing unit of a web-fed rotary press;

FIG. 6 shows the section VI-VI according to FIG. 5;

FIG. 7 shows the section VII-VII according to FIG. 5; and

FIG. 8 shows the section VIII-VIII according to FIG. 5.

### DETAILED DESCRIPTION OF THE PRESENTLY PREFERRED EMBODIMENTS

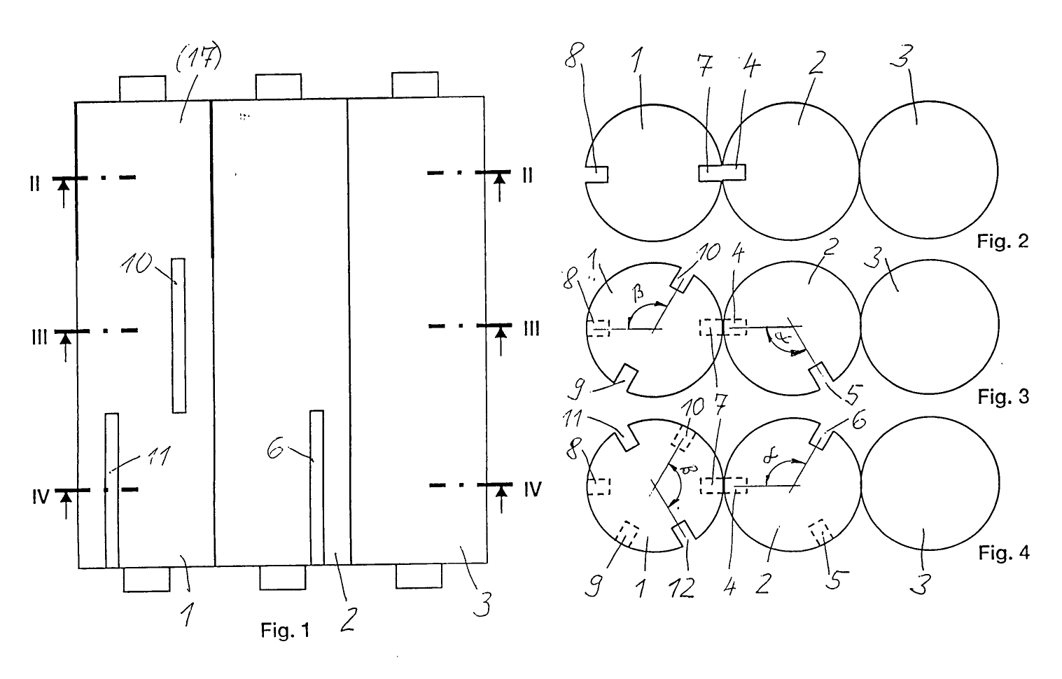

FIG. 1 shows the printing-unit cylinders of a printing unit of a web-fed rotary press in plan view. In detail, the printing unit comprises a forme cylinder 1, a transfer cylinder 2 and an impression cylinder 3 in the form of a satellite cylinder. All the cylinders 1, 2, 3 are in each case six upright broadsheet pages in width. For the sake of simplicity, other details of the printing unit, such as the frame, are not shown. Three rubber blankets, each two pages in width, can be clamped next to one another on the transfer cylinder 2 in a respective clamping channel 4, 5, 6. The clamping channels 4, 5, 6 are offset in the circumferential direction of the transfer cylinder 2 in each case by an angle α of 120° with respect to one another (FIGS. 2, 3, 4). The transfer cylinder 2 has a circumference of two upright broadsheet pages. The forme cylinder 1, which is in rolling contact with the transfer cylinder 2, likewise has a circumference of two upright broadsheet pages. The forme cylinder 1 can be fitted in the circumferential direction with two printing plates which can be clamped in clamping channels 7 to 12 lying opposite one another. In each case one (7, 9, 11) of these clamping channels 7 to 12 of the forme cylinder 1 comes to lie opposite a clamping channel 4, 5, 6 of the transfer cylinder when in rolling contact with the transfer cylinder 2. The planes comprising the mutually opposite clamping channels 7, 8 and 9, 10 and 11, 12 are offset in the circumferential direction in each case by an angle β of 1200. The clamping channels 8, 10, 12 of the forme cylinder 1, which lie opposite the clamping channels 7, 9, 11 and do not come into contact with the clamping channels 4, 5, 6 of the transfer cylinder 2, also roll on the transfer cylinder 2 in such a sequence that the contact force to the transfer cylinder 2 is never interrupted on more than a third of the cylinder. The clamping channels 4, 5, 6 of the transfer cylinder 2 likewise roll on the satellite cylinder 3 such that only one clamping channel 4, 5, 6 comes into contact at any one time with the satellite cylinder 3 and the contact force to the latter is not interrupted on more than a third of the cylinder.

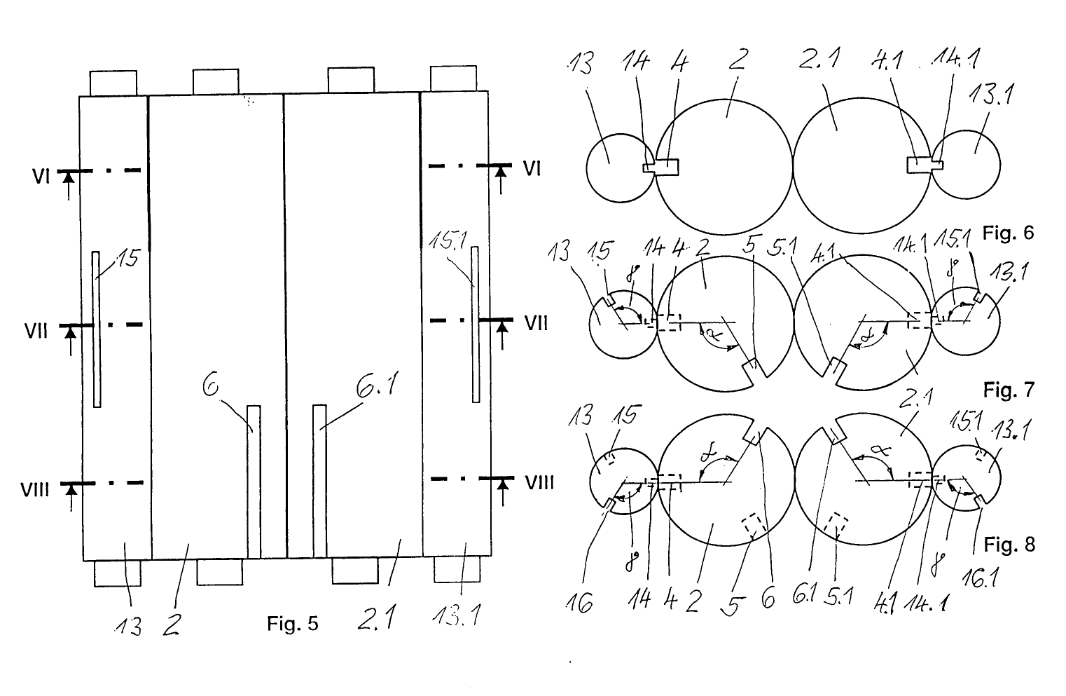

FIG. 5 shows the plan view of the printing-unit cylinders of what is called a double printing unit. In detail, these are the transfer cylinders 2 and 2.1 and also the forme cylinders 13 and 13.1. For the sake of simplicity, the item numbers of the previous exemplary embodiment have been retained for the transfer cylinder 2, as it is a cylinder of identical type. Another description of the construction is also omitted in order to avoid repetition. All four printing-unit cylinders 2, 2.1, 13, 13.1 are in each case six upright broadsheet pages in width. The transfer cylinder 2.1 is constructed mirror-symmetrically in relation to the transfer cylinder 2. It therefore has a circumference of two upright broadsheet pages. Three rubber blankets, each of which is two pages in width, can be clamped in the axial direction into a respective clamping channel 4.1, 5.1, 6.1, these clamping channels 4.1, 5.1, 6.1 being offset in the circumferential direction in each case by an angle α of 120° in relation to one another.

The forme cylinder 13 has a circumference of one upright broadsheet page and can be fitted in the circumferential direction with one printing plate, it being possible to clamp the printing plates in clamping channels 14, 15, 16. The clamping channels 14, 15, 16 are arranged such that they come to lie opposite the clamping channels 4, 5, 6 of the transfer cylinder 2 when in rolling contact with the latter. The clamping channels 14, 15, 16 of the forme cylinder 13 are thus offset in the circumferential direction in each case by an angle γ of 120° in relation to one another.

The forme cylinder 13.1 is constructed mirror-symmetrically in relation to the forme cylinder 13. It has 3 clamping channels 14.1, 15.1, 16.1 which come to lie opposite the clamping channels 4.1, 5.1, 6.1 of the transfer cylinder 2.1 when in rolling contact with the latter. The forme cylinder 13.1 thus comprises one clamping channel 14.1, 15.1, 16.1 in each longitudinal third, and these clamping channels are offset in the circumferential direction of the forme cylinder 13.1 in each case by an angle γ of 120° in relation to one another.

When the forme cylinder 13 is in rolling contact with the transfer cylinder 2, only one clamping channel 14, 15, 16, extending over a longitudinal third of the forme cylinder 13, comes into contact at any one time with the transfer cylinder 2, so that the contact force is never interrupted on more than a third of the cylinder. The same applies when the forme cylinder 13.1 is in rolling contact with the transfer cylinder 2.1. Likewise, in each case only one clamping channel 4 and 4.1 or 5 and 5.1 or 6 and 6.1, extending over a longitudinal third, comes into contact with the other transfer cylinder 2, 2.1 when the transfer cylinder 2 is in rolling contact with the transfer cylinder 2.1, so that the contact force is never interrupted on more than a third of the cylinder.

The indicated arrangement of the clamping channels 4, 5, 6, 4.1, 5.1, 6.1 is also of advantage if a forme cylinder is configured without clamping channels and bears printing-plate sleeves 17 (shown in brackets as a variant in FIG. 1). Only one clamping channel 4, 5, 6 of the transfer cylinder 2 comes into contact at any one time with the forme cylinder 1 during rolling contact in this case as well, so that the contact force is never interrupted on more than a third of the cylinder.

The printing units of the exemplary embodiments operate according to the offset process, but could also operate in accordance with an indirect gravure or letterpress printing process.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing unit of a web-fed rotary printing press for newspaper printing, said printing unit comprising:
a forme cylinder which is six upright broadsheet pages in width;
a transfer cylinder which is six upright broadsheet pages in width and has three clamping channels for clamping three rubber blankets, wherein each blanket is two pages in width, wherein said clamping channels are offset from each other by approximately 120°; and
an impression cylinder.

2. A printing unit as in claim 1 wherein said forme cylinder has a circumference of two upright broadsheet pages, said forme cylinder having three pairs of diametrically opposed clamping channels for clamping three respective pairs of printing plates, each pair of printing plates being fitted in the circumferential direction, only one of said clamping channels of said forme cylinder lying opposite a clamping channel of said transfer cylinder when said forme cylinder is in rolling contact wih said transfer cylinder.

3. A printing unit as in claim 1 wherein said forme cylinder has a circumference of one upright broadsheet page, said forme cylinder having three clamping channels for clamping three respective printing plates, only one of said clamping channels of said forme cylinder lying opposite a clamping channel of said transfer cylinder when said forme cylinder is in rolling contact with said transfer cylinder.

4. A printing unit as in claim 1 wherein said impression cylinder comprises a transfer cylinder of a further printing unit, said transfer cylinder of said further printing unit being six upright broadsheet pages in width and having three clamping channels for clamping three rubber blankets, wherein each blanket is two pages in width, wherein said clamping channels of said transfer cylinder of said further printing unit are offset from each other by approximately 120°

5. A printing unit as in claim 1 wherein said impression cylinder is a satellite cylinder.

6. A printing unit as in claim 1 wherein said printing unit operates according to one of the offset, gravure, and letterpress printing processes.

7. A printing unit as in claim 1 wherein said forme cylinder comprises a printing plate sleeve.
